(19) United States
(12) Patent Application Publication
(10) Pub. No.: US 2013/0336154 A1
(43) Pub. Date: Dec. 19, 2013

(54) Sharing Radio Resources Between Access Nodes with Different Access Restrictions

(71) Applicants: Klaus Ingemann Pedersen, Aalborg (DK); Frank Frederiksen, Klarup (DK); Yuanye Wang, San Diego, CA (US)

(72) Inventors: Klaus Ingemann Pedersen, Aalborg (DK); Frank Frederiksen, Klarup (DK); Yuanye Wang, San Diego, CA (US)

(73) Assignee: Nokia Siemens Networks Oy, Espoo (FI)

(21) Appl. No.: 14/000,412

(22) PCT Filed: Mar. 1, 2011
(86) PCT No.: PCT/EP2011/053011

§ 371 Date: Aug. 20, 2013

(51) Int. Cl. H04W 24/08

(52) U.S. Cl. CPC H04W 24/08
USPC 370/252

(57) ABSTRACT

Determining at a communication device served by a first access node whether transmissions from said first access node to said communication device are at at least a predetermined level of risk of interference by transmissions from one or more second access nodes inaccessible to said communication device; and, if so, transmitting an indication of said determination towards said first access node.

Some communication systems involve access nodes with overlapping coverage areas and sharing radio resources for wireless transmissions to and from communication devices. Such a communication system can include one or more access nodes having overlapping coverage areas and different access restrictions.

A communication device can be understood as a device provided with appropriate communication and control capabilities for enabling use thereof for communication with other parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof.

A wireless access system typically operates in accordance with a wireless standard and/or with a set of specifications which set out what the various elements of the system are permitted to do and how that should be achieved. Examples include GSM (Global System for Mobile) EDGE (Enhanced Data for GSM Evolution) Radio Access Networks (GERAN), Universal Terrestrial Radio Access Networks (UTRAN), and evolved Universal Terrestrial Radio Access Networks (EUTRAN). For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

With a communication system involving access nodes having different access restrictions and sharing radio resources in one or more overlapping coverage areas, there has been identified the possibility of a communication device served by one access node finding itself in a location relatively close to another access node to which the communication device is barred from access. It is an aim to provide one or more techniques of use in such situations.

There is provided a method comprising: determining at a communication device served by a first access node whether transmissions from said first access node to said communication device are at at least a predetermined level of risk of interference by transmissions from one or more second access nodes inaccessible to said communication device; and, if so, transmitting an indication of said determination towards said first access node.

In one embodiment, said determining comprises: determining whether a measurement of received quality for one or more transmissions from said first access node is smaller than a predetermined first threshold value; and determining whether a measurement of received power for one or more transmissions from at least one second access node inaccessible to said communication device is greater than a predetermined second threshold value.

In one embodiment, said one or more transmissions from said first access node are one or more reference signals broadcast by said first access node; and said one or more transmissions from said at least one second access node are reference signals broadcast by said at least one second access node.

In one embodiment, said determining comprises: determining whether a measurement of received power for one or more transmissions from at least one second access node inaccessible to said communication device exceeds a measurement of received power for one or more transmissions from the first access node by more than a predetermined first threshold value; and determining whether a measurement of received power for one or more transmissions from at least one second access node inaccessible to said communication device exceeds a predetermined second threshold value.

In one embodiment, said one or more transmissions from said first access node are one or more reference signals broadcast by said first access node; and said one or more transmissions from said at least one second access node are reference signals broadcast by said at least one second access node.

There is also provided a method comprising: receiving at a first access node from a communication device served by said first access node an indication that transmissions from said first access node to said communication device are at at least a predetermined level of risk of interference by transmissions from one or more second access nodes inaccessible to said communication device; and selecting for transmissions from said first access node to said communication device resources not used by said one or more second access nodes for transmissions from said one or more second access nodes.

There is also provided a method comprising: determining at an access network serving a communication device whether transmissions to said communication device from a first access node serving said communication device are at at least a predetermined level of risk of interference by transmissions from one or more second access nodes inaccessible to said communication device; and, if so, selecting for transmissions from said first access node to said communication device resources not used by said one or more second access nodes for transmissions from said one or more second access nodes.

In one embodiment, said determining comprises (i) determining whether there is an indication from said communication device that a measurement of a first parameter for one or more transmissions from a second access node inaccessible to said communication device fulfils a predetermined first condition in relation to a measurement of said first parameter for one or more transmissions from said first access node; and (ii) determining whether there is a separate indication from said communication device that a measurement of said first parameter for one or more transmissions from a second access node inaccessible to said communication device fulfils a predetermined second condition in relation to a predetermined absolute reference value for said first parameter.

In one embodiment, said one or more transmissions from a second access node are one or more reference signals broadcast by said second access node, said one more transmissions from said first access node are one or more reference signals broadcast by said first access node, and said first parameter is received quality or received power. There is also provided an apparatus comprising: a processor and memory including computer program code, wherein the memory and computer program code are configured to, with the processor, cause the apparatus to: determine at a communication device served by a first access node whether transmissions from said first access node to said communication device are at at least a predetermined level of risk of interference by transmissions from one or more second access nodes inaccessible to said communication device; and, if so, to transmit an indication of said determination towards said first access node.

In one embodiment, said memory and computer program code are configured to, with the processor, cause the apparatus to: determine whether a measurement of received quality for one or more transmissions from said first access node is smaller than a predetermined first threshold value; and determine whether a measurement of received power for one or more transmissions from at least one second access node inaccessible to said communication device is greater than a predetermined second threshold value.

In one embodiment, said one or more transmissions from said first access node are one or more reference signals broadcast by said first access node; and said one or more transmissions from said at least one second access node are reference signals broadcast by said at least one second access node.

In one embodiment, the memory and computer program code are configured to, with the processor, cause the apparatus to determine whether a measurement of received power for one or more transmissions from at least one second access node inaccessible to said communication device exceeds a measurement of received power for one or more transmissions from the first access node by more than a predetermined first threshold value; and determine whether a measurement of received power for one or more transmissions from at least one second access node inaccessible to said communication device exceeds a predetermined second threshold value.

In one embodiment, said one or more transmissions from said first access node are one or more reference signals broadcast by said first access node; and said one or more transmissions from said at least one second access node are reference signals broadcast by said at least one second access node.

There is also provided an apparatus comprising: a processor and memory including computer program code, wherein the memory and computer program code are configured to, with the processor, cause the apparatus to: receive at a first access node from a communication device served by said first access node an indication that transmissions from said first access node to said communication device are at at least a predetermined level of risk of interference by transmissions from one or more second access nodes inaccessible to said communication device; and select for transmissions from said first access node to said communication device resources not used by said one or more second access nodes for transmissions from said one or more second access nodes.

There is also provided an apparatus comprising: a processor and memory including computer program code, wherein the memory and computer program code are configured to, with the processor, cause the apparatus to: determine at an access network serving a communication device whether transmissions to said communication device from a first access node serving said communication device are at at least a predetermined level of risk of interference by transmissions from one or more second access nodes inaccessible to said communication device; and, if so, to select for transmissions from said first access node to said communication device resources not used by said one or more second access nodes for transmissions from said one or more second access nodes.

In one embodiment, the memory and computer program code are configured to, with the processor, cause the apparatus to determine whether there is (i) an indication from said communication device that a measurement of a first parameter for one or more transmissions from a second access node inaccessible to said communication device fulfils a predetermined first condition in relation to a measurement of said first parameter for one or more transmissions from said first access node; and (ii) a separate indication from said communication device that a measurement of said first parameter for one or more transmissions from a second access node inaccessible to said communication device fulfils a predetermined second condition in relation to a predetermined absolute reference value for said first parameter.

In one embodiment, said one or more transmissions from a second access node are one or more reference signals broadcast by said second access node, said one more transmissions from said first access node are one or more reference signals broadcast by said first access node, and said first parameter is received quality or received power. There is also provided an apparatus configured to carry out any of the above methods.

There is also provided user equipment, a base station or an eNodeB comprising the above apparatus.

There is also provided a computer program product comprising program code means which when loaded into a computer controls the computer to: determine at a communication device served by a first access node whether transmissions from said first access node to said communication device are at at least a predetermined level of risk of interference by transmissions from one or more second access nodes inaccessible to said communication device; and, if so, to transmit an indication of said determination towards said first access node.

There is also provided a computer program product comprising program code means which when loaded into a computer controls the computer to: receive at a first access node from a communication device served by said first access node an indication that transmissions from said first access node to said communication device are at at least a predetermined level of risk of interference by transmissions from one or more second access nodes inaccessible to said communication device; and select for transmissions from said first access node to said communication device resources not used by said one or more second access nodes for transmissions from said one or more second access nodes.

There is also provided a computer program product comprising program code means which when loaded into a computer controls the computer to: determine at an access network serving a communication device whether transmissions to said communication device from a first access node serving said communication device are at at least a predetermined level of risk of interference by transmissions from one or more second access nodes inaccessible to said communication device; and, if so, to select for transmissions from said first access node to said communication device resources not used by said one or more second access nodes for transmissions from said one or more second access nodes.

Hereunder, embodiments of the present invention will be described in detail, by way of example only, with reference to the following drawings, in which:

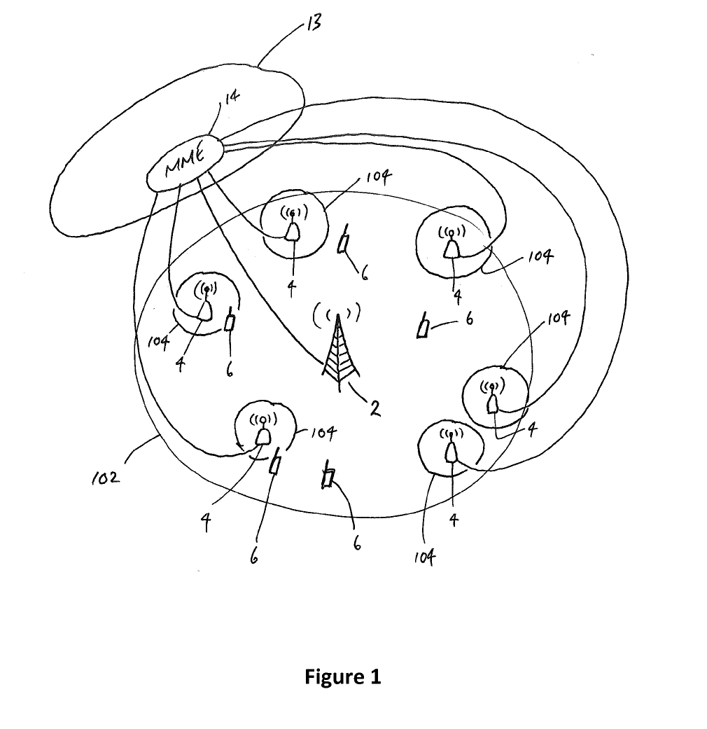

FIG. 1 illustrates an example of a heterogeneous network within which embodiments of the invention may be implemented, which network includes a macro eNB serving a relatively wide area and CSG eNBs serving respective smaller areas within the area served by the macro eNB.

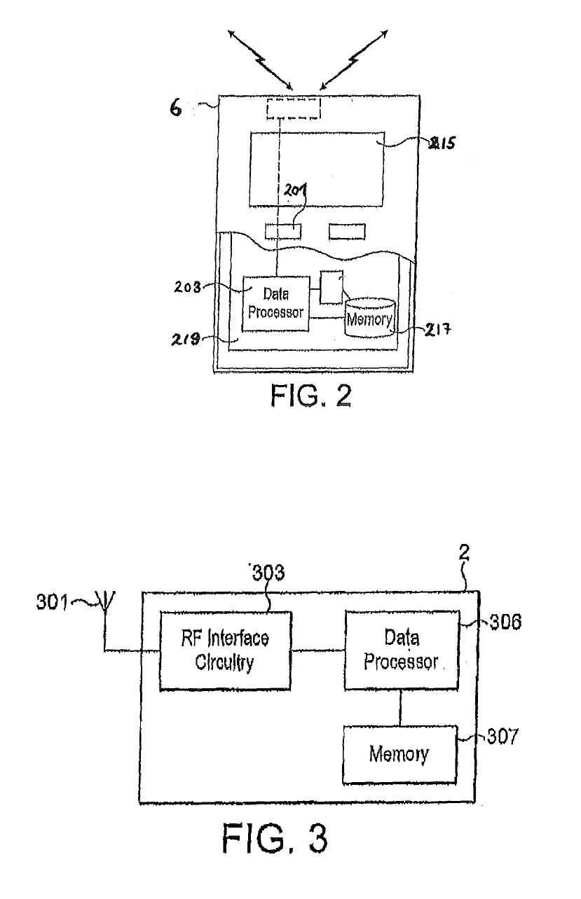

FIG. 2 illustrates an example of user equipment shown in FIG. 1 in further detail;

FIG. 3 illustrates an example of an apparatus suitable for implementing an embodiment of the invention at a CSG eNB or macro eNB of the network shown in FIG. 1;

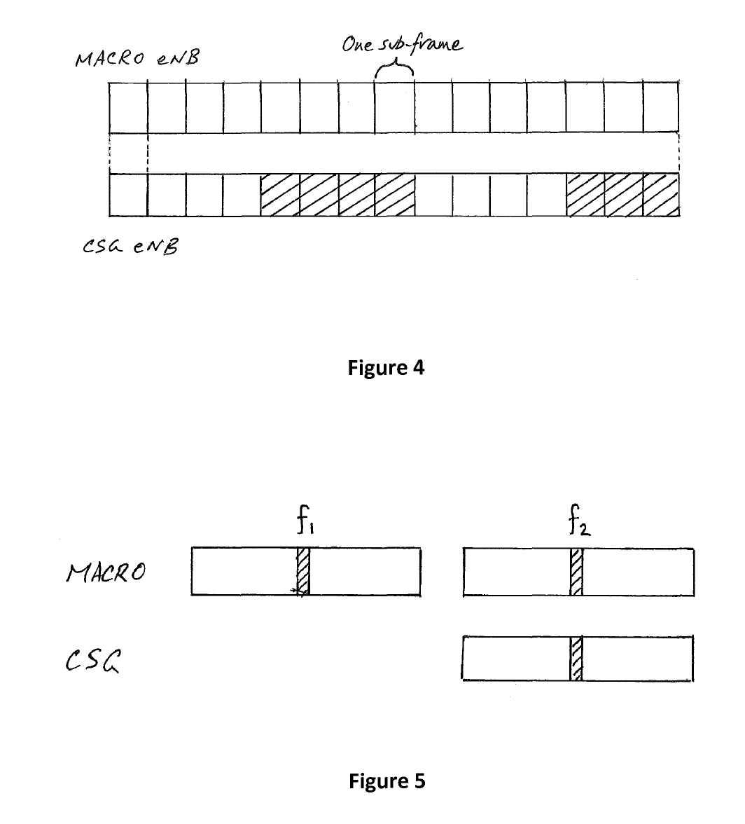

FIG. 4 illustrates time-domain enhanced inter-cell interference coordination;

FIG. 5 illustrates frequency-domain enhanced inter-cell interference coordination;

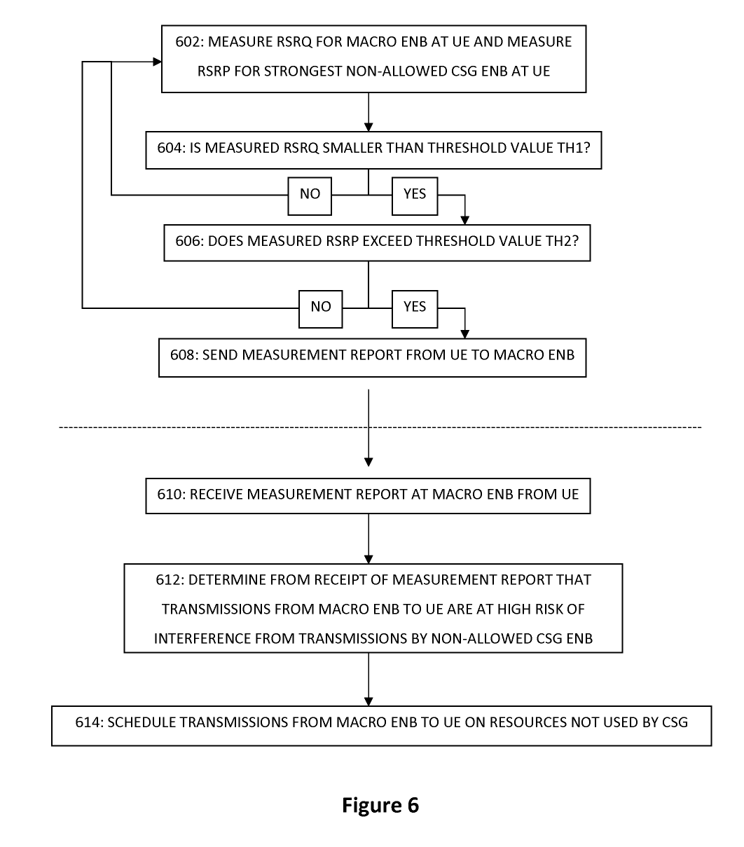

FIG. 6 illustrates an example of operations at user equipment and macro eNB in FIG. 1 in accordance with an embodiment of the present invention;

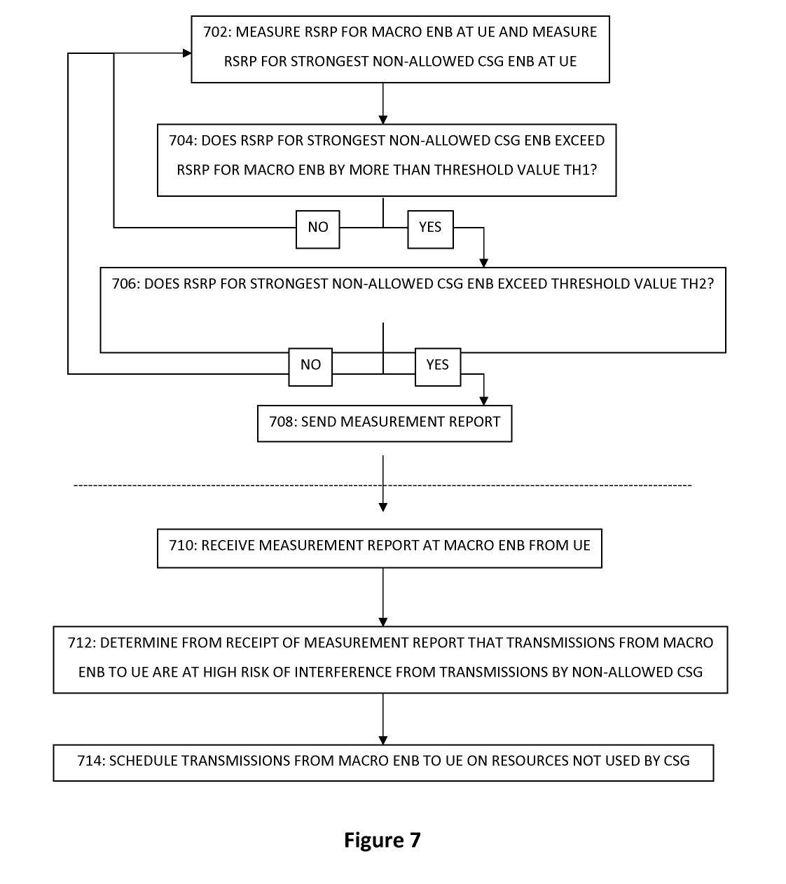

FIG. 7 illustrates another example of operations at user equipment and macro eNB of FIG. 1 in accordance with an embodiment of the present invention; and

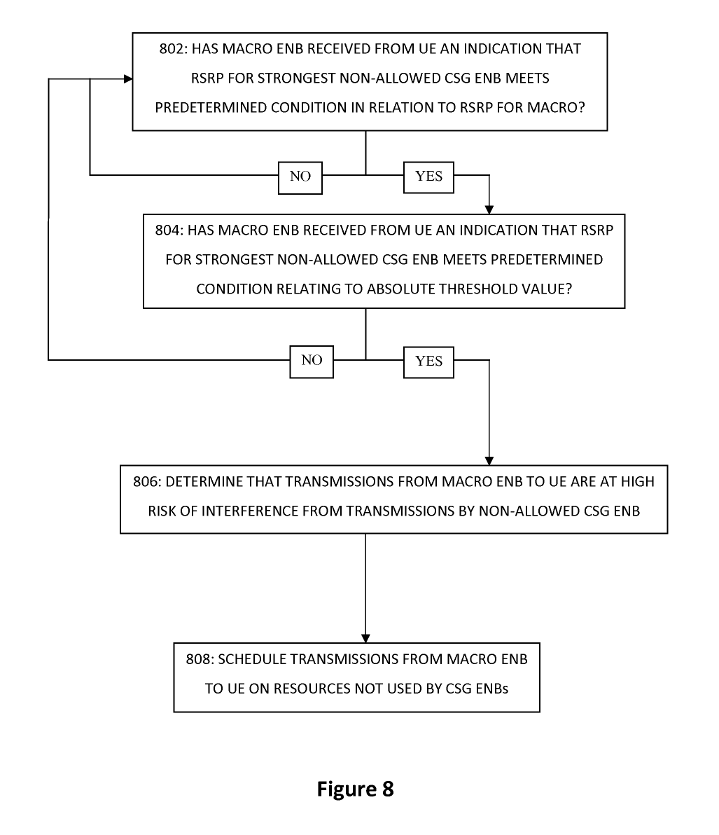

FIG. 8 illustrates an example of operations at a macro-eNB of FIG. 1 in accordance with another embodiment of the present invention.

Embodiments of the invention are described below, by way of example only, in the context of a Long Term Evolution (LTE) or LTE-Advanced (LTE-A) system including closed subscriber group (CSG) eNodeBs (eNBs); but the same kind of techniques are also of use in other systems, such as networks including High Speed Packet Access (HSPA) Femto cells.

One simple example of a heterogeneous network including cells with different access restrictions is illustrated in FIG. 1. A eNB 2 (macro eNB) provides access to users over a relatively wide area 102 with relatively little limitation on access by users. Within this wide coverage area 102 also operate a plurality of eNBs 4 that have relatively small coverage areas 104 and limit access rights to only users belonging to a closed subscriber group (CSG). One example of such a CSG eNB is an eNB installed in a home/office and allowing access by family/office members only (Home eNodeB (HeNB)).

The macro eNB 2 and the CSG eNBs 4 are all connected to a mobile management entity 13 of a core network 14. UE 6 stores a list of CSG ID numbers identifying the CSG eNBs that it is allowed to access (“allowed CSGs”); and accessibility to a CSG eNB cell is determined based on whether the CSG ID included in the information broadcast by that CSG eNB is included in this list or not.

The macro eNB 2 will typically be one of a large number of macro eNBs forming part of a cellular network. Likewise, the area served by each macro eNB 2 will typically include a large number of CSG eNBs 4. The macro eNB 2 and the CSG eNBs 4 within the coverage area 102 of the macro eNB 2 share frequency resources.

FIG. 2 shows a schematic partially sectioned view of an example of user equipment 6 that may be used for communicating with the macro eNB 2 and/or a CSG eNB 4 of FIG. 1 via a wireless interface. The user equipment (UE) 6 may be used for various tasks such as making and receiving phone calls, for receiving and sending data from and to a data network and for experiencing, for example, multimedia or other content.

The UE 6 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 6 may communicate via an appropriate radio interface arrangement of the UE 6. The interface arrangement may be provided for example by means of a radio part and associated antenna arrangement. The antenna arrangement may be arranged internally or externally to the UE 6.

The UE 6 may be provided with at least one data processing entity 203 and at least one memory or data storage entity 217 for use in tasks it is designed to perform. The data processor 213 and memory 217 may be provided on an appropriate circuit board 219 and/or in chipsets.

The user may control the operation of the UE 6 by means of a suitable user interface such as key pad 201, voice commands, touch sensitive screen or pad, combinations thereof or the like. A display 215, a speaker and a microphone may also be provided. Furthermore, the UE 6 may comprise appropriate connectors (either wired or wireless) to other devices and/or for connecting external accessories, for example hands-free equipment, thereto.

FIG. 3 shows an example of apparatus for use at the CSG eNBs 4 and/or the macro eNB 2. The apparatus comprises a radio frequency antenna 301 configured to receive and transmit radio frequency signals; radio frequency interface circuitry 303 configured to interface the radio frequency signals received and transmitted by the antenna 301 and the data processor 306. The radio frequency interface circuitry 303 may also be known as a transceiver. The data processor 306 is configured to process signals from the radio frequency interface circuitry 303, control the radio frequency interface circuitry 303 to generate suitable RF signals to communicate information to the UE 6 via the wireless communications link. The memory 307 is used for storing data, parameters and instructions for use by the data processor 306.

It would be appreciated that both the UE 6 and the apparatus shown in FIGS. 2 and 3 respectively and described above may comprise further elements which are not directly involved with the embodiments of the invention described hereafter.

Where UE 6 is in the vicinity of a CSG eNB 4 that shares frequency resources with the macro eNB 2 and to which the UE 6 does not have access rights (“non-allowed CSG eNB”), there is a concern that transmissions from the macro eNB 2 to that UE 6 are at a high risk of interference from transmissions made by the non-allowed CSG eNB 4. This is of particular concern where the non-allowed CSG eNB 4 is at the edge of the coverage area for the macro eNB 2 or in another physical location where the environment is such that the received quality of transmissions from the macro eNB 2 is relatively poor.

One technique for managing interference in such a situation is time-domain (TDM) or frequency domain (FDM) enhanced inter-cell interference coordination (eICIC). When the radio access network controlling the macro eNB 2 detects that UE 6 served by the macro eNB 2 is in the dominance area of a non-allowed CSG eNB 4 (which dominance area can be referred to as a macro-layer coverage-hole), then the radio access network is configured to either serve such UEs on subframes when CSG eNBs 4 are muted (in the case of TDM eICIC), or via a frequency carrier on which the CSG eNBs 4 are not allowed to transmit (FDM eICIC).

TDM eICIC is illustrated in FIG. 4, in which the use of downlink sub-frames at the two network layers (macro eNB and CSG eNB layers) is depicted. There is strict time synchronisation between the macro eNB 2 and the CSG eNBs 4. FIG. 4 shows the 14 sub-frames consisting each single frame, and the unshaded sub-frames in FIG. 4 indicate sub-frames with normal transmission, and the shaded sub-frames in FIG. 4 indicate almost blank, or MBSFN (Multi-Media Broadcast over a Single Frequency Network) sub-frames. The macro eNB 2 is active in all sub-frames (i.e. is transmitting as “normal”). All CSG eNBs 4 only make substantial transmissions in a sub-set of the sub-frames—and the remaining sub-frames are almost blank. In this context, “almost blank” refers to cases with nearly no transmission from the CSG eNBs 4. Transmissions from a macro eNB 2 to UE 6 close to a CSG eNB 4 to which said UE 6 does not have access rights are scheduled for sub-frames designated as blank sub-frames for CSG eNBs (i.e. the shaded sub-frames in FIG. 4); on the other hand, transmissions from the macro eNB 2 to other UE 6 at less risk of interference from transmissions by a non-allowed CSG eNB (e.g. because they are further away from any non-allowed CSG eNB 4) are preferentially (but not necessarily exclusively) scheduled in other sub-frames (i.e. sub-frames in which CSG eNBs do make substantial transmissions).

The macro eNB 2 knows in which sub-frames CSG eNBs 4 are muted. For this kind of interference management technique to perform optimally, UE 6 served by the macro eNB 2 and close to one or more non-allowed CSG eNBs 4 are subject to restrictions on when they can make measurements; measurements for Radio Link Monitoring (RLM), Radio Resource Management (RRM), and Channel State Information (CSI) are conducted by such UE 6 only during subframes when CSG eNBs are muted. The aim is to avoid such measurements of signals from the macro eNB being corrupted by interference from transmissions by CSG eNBs 4.

A basic example of FDM eICIC is illustrated in FIG. 5. The macro eNB 2 can make transmissions on two frequency carriers and CSG eNBs 4 only make transmissions on one of those two frequency carriers. The other of the two frequency carriers is therefore free of interference from transmissions by CSG eNBs 4 and is referred to hereafter as the ‘escape carrier’. Transmissions from the macro eNB 2 to UE 6 at high level of risk of interference from transmissions by one or more non-allowed CSG eNBs are made using the escape carrier (i.e. one or more frequency carriers that CSG eNBs 4 do not use for transmissions), while transmissions from the macro eNB 2 to other UE 6 are made preferentially (but not necessarily exclusively) using one or more frequency carriers that the macro eNB 2 shares with CSG eNBs 4.

The above-described eICIC techniques are examples of situations in which it would be useful for a macro eNB 2 to know when transmissions from the macro eNB 2 to a UE 6 are at a relatively high risk of interference from transmissions by a non-allowed CSG eNB 4.

According to a first embodiment of the present invention, UE 6 is configured to send (Step 608 of FIG. 6) a measurement report to the macro eNB (serving cell) whenever both the following conditions are fulfilled: (a) the reference signal reference quality (RSRQ) for the macro eNB serving cell as measured at UE 6 (Step 602) is smaller than a predetermined threshold value TH1 (Yes to Question 604 of FIG. 6); and (b) the reference signal received power (RSRP) as measured by the UE 6 (Step 602) for the non-allowed CSG eNB 4 (out of all those non-allowed CSG eNBs 4 that share frequency resources with the macro eNB) from which UE 6 receives reference signals with the highest received power (hereafter referred to as the strongest non-allowed CSG eNB) is larger than a predetermined threshold value TH2 (YES to Question 606 of FIG. 6). The threshold values TH1 and TH2 can be configuration parameters that are signalled to the UE 6 from the network as part of, for example, Radio Resource Control (RRC) signalling. A low RSRQ measurement for the macro eNB serving cell indicates that transmissions from macro eNB 2 to UE 6 are at a high risk of strong interference. A high RSRP measurement for the strongest non-allowed CSG eNB indicates that UE 6 is experiencing strong signalling from a non-allowed CSG eNB. A combination of these measurements indicates that transmissions from macro eNB to UE 6 are at a high risk of strong interference from transmissions by a non-allowed CSG eNB sharing frequency resources with the macro eNB.

Whereas the macro eNB 2 might also receive other indications that transmissions from macro eNB to UE 6 are at a high risk of interference from transmissions from some other source (which might or might not be a non-allowed CSG eNB), the above-mentioned measurement report provides a specific indication that transmissions from the macro eNB to UE 6 are at a high risk of interference from a eNB to which a handover of UE 6 cannot be arranged, i.e. a non-allowed CSG eNB.

According to a second embodiment of the present invention, UE 6 sends (Step 708 of FIG. 7) a measurement report to macro eNB 2 (its serving cell) whenever both the following conditions are fulfilled: (a) the RSRP as measured at UE 6 (Step 702) for the strongest non-allowed CSG eNB is higher than the RSRP as measured at UE 6 for the macro eNB (serving cell) by more than a predetermined first threshold value TH1 [dB] (YES to Question 704 of FIG. 7); and (b) the RSRP as measured at UE 6 (Step 702) for the strongest non-allowed CSG eNB is higher than a predetermined second threshold value TH2 [dBm] (YES to Question 706 of FIG. 7). These two conditions can be represented by the following equation:

RSRP_{strongest co-channel deployed non-allowed CSG HeNB}>max{RSRP_{serving cell}+TH1,TH2}

The predetermined threshold values TH1 and TH2 in this second embodiment can be configuration parameters that are signalled to UE 6 from the radio access network using, for example, RRC signalling.

According to a third embodiment, the radio access network makes a determination as to whether transmissions from macro eNB to UE 6 are at a high risk of interference from transmissions by a non-allowed CGS eNB, based on a combination of separate measurement reports from UE 6.

Firstly, UE 6 is configured to send a measurement report to the radio access network whenever a measurement at UE of RSRP for a non-allowed CSG eNB meets a predetermined condition relating to a measurement at the UE of RSRP for macro eNB (serving cell). By way of example, the above-mentioned predetermined condition could be of the kind used as Entering Condition for Event A3 described at Section 5.5.4.4 of 3GPP TS 36.331 (V10.0.0), with a modification to require that the entering condition is only met if an inequality such as Inequality A3-1 is met for a non-allowed CSG eNB. By controlling the sending of measurement reports using the kind of leaving and entering conditions defined at Section 5.5.4.4 of 3GPP TS 36.331 (V10.0.0) for the specific case of non-allowed CSG eNBs only, it is possible for the radio access network to thus identify whether the received quality of transmissions from macro eNB 2 to UE 6 is at risk of degradation by transmissions from a non-allowed CSG eNB 4. Secondly, UE 6 is also configured to send a separate measurement report whenever a measurement at UE 6 of RSRP for a non-allowed CSG eNB 4 meets a predetermined condition relating to a predetermined absolute threshold value. By way of example, the above-mentioned predetermined condition could be of the kind used as Entering Condition for Event A4 described at Section 5.5.4.5 of 3GPP TS 36.331 (V10.0.0), with a modification to require that the entering condition is only met if an inequality such as Inequality A4-1 is met for a non-allowed CSG eNB. The receipt at macro eNB 2 of such a measurement report from UE 6 indicates the existence of strong interference from a non-allowed CSG eNB 4.

As mentioned above, the above-described measurement reports are of use in eICIC techniques. Reception (Step 610 of FIG. 6 and Step 710 of FIG. 7) at macro eNB 2 from UE 6 of a measurement report of the kind described above for the first and second embodiments, or the reception (Yes to Questions 802 and 804 of FIG. 8) at macro eNB 2 of a combination of measurement reports of the kind described above for the third embodiment can be used as a trigger (Steps 612, 712 and 806) for macro eNB 2 to schedule transmissions from macro eNB 2 to UE 6 on time or frequency resources not used by CSG eNBs 4 (Steps 614, 714, and 808).

The measurement of RSRP for non-allowed CSG eNBs 4 that share frequency resources with macro eNB 2 could, for example, be implemented as follows. Macro-eNB 2 broadcasts information about the range of physical Cell IDs (PCI) reserved for CSG eNBs 4. Upon detecting broadcast signalling from another eNB, the UE 6 served by the macro eNB 2 would know from the PCI information included as part of the broadcast signalling whether the source of the broadcast signalling is a CSG eNB or another macro eNB. UE 6 would then read the CSG ID of the detected CSG eNB from the system information block included as part of the broadcast signalling from the detected CSG eNB, and compare the read CSG ID against the list of allowed CSG IDs stored at UE 6. If UE 6 does not have access rights to any CSG eNB 4 (i.e. if the list of allowed CSG IDs is empty), then the detected CSG eNB is by definition a non-allowed CSG eNB.

For each of the above embodiments, RSRP and RSRQ measurements are used as the basis for a determination as to whether transmissions from a macro eNB to UE 6 are at a high level of interference from transmissions from a non-allowed CSG eNB; but such determination can be made on the basis of other types of measurements or different combinations of the same type of measurements. For example, where a RSRP measurement is used in any of the embodiments described above, a RSRQ measurement could alternatively be used, and vice versa. The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1. A method, comprising: determining at a communication device served by a first access node whether transmissions from said first access node to said communication device are at at least a predetermined level of risk of interference by transmissions from one or more second access nodes inaccessible to said communication device; and, if so, transmitting an indication of said determination towards said first access node.

2. A method according to claim 1, wherein said determining comprises:
determining whether a measurement of received quality for one or more transmissions from said first access node is smaller than a predetermined first threshold value; and
determining whether a measurement of received power for one or more transmissions from at least one second access node inaccessible to said communication device is greater than a predetermined second threshold value.

3. A method according to claim 2, wherein said one or more transmissions from said first access node are one or more reference signals broadcast by said first access node; and said one or more transmissions from said at least one second access node are reference signals broadcast by said at least one second access node.

4. A method according to claim 1, wherein said determining comprises:
determining whether a measurement of received power for one or more transmissions from at least one second access node inaccessible to said communication device exceeds a measurement of received power for one or more transmissions from the first access node by more than a predetermined first threshold value; and determining whether a measurement of received power for one or more transmissions from at least one second access node inaccessible to said communication device exceeds a predetermined second threshold value.

5. A method according to claim 4, wherein said one or more transmissions from said first access node are one or more reference signals broadcast by said first access node; and said one or more transmissions from said at least one second access node are reference signals broadcast by said at least one second access node.

6. A method comprising: receiving at a first access node from a communication device served by said first access node an indication that transmissions from said first access node to said communication device are at at least a predetermined level of risk of interference by transmissions from one or more second access nodes inaccessible to said communication device; and selecting for transmissions from said first access node to said communication device resources not used by said one or more second access nodes for transmissions from said one or more second access nodes.

7. A method comprising: determining at an access network serving a communication device whether transmissions to said communication device from a first access node serving said communication device are at at least a predetermined level of risk of interference by transmissions from one or more second access nodes inaccessible to said communication device; and, if so, selecting for transmissions from said first access node to said communication device resources not used by said one or more second access nodes for transmissions from said one or more second access nodes.

8. A method according to claim 7, wherein said determining comprises (i) determining whether there is an indication from said communication device that a measurement of a first parameter for one or more transmissions from a second access node inaccessible to said communication device fulfils a predetermined first condition in relation to a measurement of said first parameter for one or more transmissions from said first access node; and (ii) determining whether there is a separate indication from said communication device that a measurement of said first parameter for one or more transmissions from a second access node inaccessible to said communication device fulfils a predetermined second condition in relation to a predetermined absolute reference value for said first parameter.

9. A method according to claim 8, wherein said one or more transmissions from a second access node are one or more reference signals broadcast by said second access node, said one more transmissions from said first access node are one or more reference signals broadcast by said first access node, and said first parameter is received quality or received power.

10. An apparatus comprising: a processor and memory including computer program code, wherein the memory and computer program code are configured to, with the processor, cause the apparatus to: determine at a communication device served by a first access node whether transmissions from said first access node to said communication device are at at least a predetermined level of risk of interference by transmissions from one or more second access nodes inaccessible to said communication device; and, if so, to transmit an indication of said determination towards said first access node.

11. An apparatus according to claim 10, wherein said memory and computer program code are configured to, with the processor, cause the apparatus to: determine whether a measurement of received quality for one or more transmissions from said first access node is smaller than a predetermined first threshold value; and determine whether a measurement of received power for one or more transmissions from at least one second access node inaccessible to said communication device is greater than a predetermined second threshold value.

12. An apparatus according to claim 11, wherein said one or more transmissions from said first access node are one or more reference signals broadcast by said first access node; and said one or more transmissions from said at least one second access node are reference signals broadcast by said at least one second access node.

13. An apparatus according to claim 10, wherein the memory and computer program code are configured to, with the processor, cause the apparatus to determine whether a measurement of received power for one or more transmissions from at least one second access node inaccessible to said communication device exceeds a measurement of received power for one or more transmissions from the first access node by more than a predetermined first threshold value; and determine whether a measurement of received power for one or more transmissions from at least one second access node inaccessible to said communication device exceeds a predetermined second threshold value.

14. A method according to claim 13, wherein said one or more transmissions from said first access node are one or more reference signals broadcast by said first access node; and said one or more transmissions from said at least one second access node are reference signals broadcast by said at least one second access node.

15. An apparatus comprising: a processor and memory including computer program code, wherein the memory and computer program code are configured to, with the processor, cause the apparatus to: receive at a first access node from a communication device served by said first access node an indication that transmissions from said first access node to said communication device are at at least a predetermined level of risk of interference by transmissions from one or more second access nodes inaccessible to said communication device; and select for transmissions from said first access node to said communication device resources not used by said one or more second access nodes for transmissions from said one or more second access nodes.

16. An apparatus comprising: a processor and memory including computer program code, wherein the memory and computer program code are configured to, with the processor, cause the apparatus to: determine at an access network serving a communication device whether transmissions to said communication device from a first access node serving said communication device are at at least a predetermined level of risk of interference by transmissions from one or more second access nodes inaccessible to said communication device; and, if so, to select for transmissions from said first access node to said communication device resources not used by said one or more second access nodes for transmissions from said one or more second access nodes.

17. An apparatus according to claim 16, wherein the memory and computer program code are configured to, with the processor, cause the apparatus to determine whether there is (i) an indication from said communication device that a measurement of a first parameter for one or more transmissions from a second access node inaccessible to said communication device fulfils a predetermined first condition in relation to a measurement of said first parameter for one or more transmissions from said first access node; and (ii) a separate indication from said communication device that a measurement of said first parameter for one or more transmissions from a second access node inaccessible to said communication device fulfils a predetermined second condition in relation to a predetermined absolute reference value for said first parameter.

18. An apparatus according to claim 17, wherein said one or more transmissions from a second access node are one or more reference signals broadcast by said second access node, said one more transmissions from said first access node are one or more reference signals broadcast by said first access node, and said first parameter is received quality or received power.

19. (canceled)

20. (canceled)

21. User equipment comprising apparatus according to claim 10.

22. A base station comprising apparatus according to claim 15.

23. A base station according to claim 22, wherein the base station is an eNodeB.

24. A computer program product comprising program code means which when loaded into a computer controls the computer to: determine at a communication device served by a first access node whether transmissions from said first access node to said communication device are at at least a predetermined level of risk of interference by transmissions from one or more second access nodes inaccessible to said communication device; and, if so, to transmit an indication of said determination towards said first access node.

25. A computer program product comprising program code means which when loaded into a computer controls the computer to: receive at a first access node from a communication device served by said first access node an indication that transmissions from said first access node to said communication device are at at least a predetermined level of risk of interference by transmissions from one or more second access nodes inaccessible to said communication device; and select for transmissions from said first access node to said communication device resources not used by said one or more second access nodes for transmissions from said one or more second access nodes.

26. A computer program product comprising program code means which when loaded into a computer controls the computer to: determine at an access network serving a communication device whether transmissions to said communication device from a first access node serving said communication device are at at least a predetermined level of risk of interference by transmissions from one or more second access nodes inaccessible to said communication device; and, if so, to select for transmissions from said first access node to said communication device resources not used by said one or more second access nodes for transmissions from said one or more second access nodes.
